(19) United States
(12) Patent Application Publication
(10) Pub. No.: US 2025/0079564 A1
(43) Pub. Date: Mar. 6, 2025

(54) COOLING MODULE AND BATTERY PACK SYSTEM INCLUDING THE SAME

(71) Applicants: HYUNDAI MOTOR COMPANY, SEOUL (KR); KIA CORPORATION, SEOUL (KR)

(72) Inventors: Kyung Mo Kim, Hwaseong-si (KR); Gun Woo Ko, Hwaseong-si (KR)

(73) Assignees: HYUNDAI MOTOR COMPANY, SEOUL (KR); KIA CORPORATION, SEOUL (KR)

(21) Appl. No.: 18/822,716

(22) Filed: Sep. 3, 2024

(30) Foreign Application Priority Data
Sep. 6, 2023 (KR) 10-2023-0118581

(51) Int. Cl. H01M 10/6556; H01M 10/613; H01M 10/6554; H01M 10/6568; H01M 50/204

(52) U.S. Cl. CPC H01M 10/6556; H01M 10/613; H01M 10/6554; H01M 10/6568; H01M 50/204

(57) ABSTRACT

A cooling module includes a fixing plate disposed on a lower side of the battery module, and including a plurality of cooling water channels extending in a first direction, and spaced apart from each other in a second direction, which is perpendicular to the first direction, and a distribution manifold disposed on an outer side of the fixing plate, and communicating the cooling water channels such that the plurality of cooling water channels form flow of cooling water along the first direction and flow of the cooling water along an opposite direction to the first direction.

### CROSS REFERENCE TO RELATED APPLICATIONS

This application claims the benefit of priority to Korean Patent Application No. 10-2023-0118581, filed in the Korean Intellectual Property Office on Sep. 6, 2023, the entire contents of which are incorporated herein by reference.

### TECHNICAL FIELD

The present disclosure relates to a cooling module and a battery pack system including the same.

### BACKGROUND

Recently, as awareness of the crisis over the environment and depletion of oil resources has increased, research and development on electric vehicles that is eco-friendly vehicles, has been highlighted.

An electric vehicle is a vehicle that runs on electricity and may include a battery pack system. The battery pack system may include a battery module including a plurality of battery cells, and a battery tray for supporting the battery module.

The battery module needs to maintain a certain temperature for the performance of the battery cells, and as a structures for this, may include an air cooling method that adjusts the temperature of the battery module by circulating air, a direct cooling method that controls the temperature of the battery module by using a refrigerant, and a water cooling method that adjusts the temperature of the battery module by using water.

Among them, the water cooling method cools the battery module by using the cooling water, and in relation to a structure for forming cooling water channels for flow of the cooling water, according to a method for forming cooling water channels through press forming, a strength is relatively low and problems are caused by brazing, and thus a need to solve these problems is increasing.

### SUMMARY

The present disclosure has been made to solve the above-mentioned problems occurring in the prior art while advantages achieved by the prior art are maintained intact.

An aspect of the present disclosure provides a cooling module that may be manufactured through extrusion instead of press forming, and a battery pack system including the same.

An aspect of the present disclosure also provides a cooling module including a fixing plate having cooling water channels as an integrated configuration, and a battery pack system including the same.

An aspect of the present disclosure also provides a cooling module, in which a distribution manifold may be accommodated in a battery tray, and a battery pack system including the same.

The technical problems to be solved by the present disclosure are not limited to the aforementioned problems, and any other technical problems not mentioned herein will be clearly understood from the following description by those skilled in the art to which the present disclosure pertains.

According to another aspect of the present disclosure, a cooling module may include a fixing plate positioned on a lower side of a battery module, and including a plurality of cooling water channels extending in a first direction, and spaced apart from each other in a second direction, which is perpendicular to the first direction, and a distribution manifold positioned on an outer side of the fixing plate, and communicating with the plurality of cooling water channels such that the plurality of cooling water channels form a flow of cooling water along the first direction and a flow of the cooling water along a third direction which is opposite to the first direction.

The distribution manifold may include a rear distribution manifold positioned on a rear side of the fixing plate in the third direction and configured to communicate with at least of the plurality of cooling water channels and at least a second of the plurality of cooling water channels such that the cooling water flowing in the first direction along the first cooling water channel circulates in the third direction along the second cooling water channel.

The rear distribution manifold may include a return pipeline positioned on an upper side of the fixing plate and extending in the second direction, and a rear connection pipeline connecting the return pipeline and the plurality of cooling water channels.

The rear connection pipeline may include a horizontal part coupled to the fixing plate and a vertical part extending from the horizontal part and connected to the return pipeline.

The distribution manifold may include a front distribution manifold positioned on a front side of the fixing plate in the third direction, and the front distribution manifold is configured to distribute the cooling water introduced from a specific introduction pipeline to a first number of the plurality of cooling water channels, and to collect the cooling water discharged from a second number of the plurality of cooling water channels, and to discharge the cooling water to a specific discharge pipeline.

The front distribution manifold may include a first front distribution manifold that is branched from the introduction pipeline to a first number of the plurality of cooling water channels, and a second front distribution manifold that is branched from the discharge pipeline to a second number of the plurality of cooling water channels.

The first front distribution manifold may include a first distribution manifold block connected to the introduction pipeline, extending in the second direction, and positioned on an upper side of the fixing plate, and a first front connection pipeline connecting the first distribution manifold block and a third number of the plurality of cooling water channels, and the second front distribution manifold may include a second distribution manifold block connected to the discharge pipeline, extending in the second direction, and positioned on the upper side of the fixing plate, and a second front connection pipeline connecting the second distribution manifold block and a fourth number of the plurality of cooling water channels.

The first front connection pipeline may include a horizontal part coupled to the fixing plate, and a vertical part extending from the horizontal part and connected to the first distribution manifold block, and the second front connection pipeline may include a horizontal part coupled to the fixing plate, and a vertical part extending from the horizontal part and connected to the second distribution manifold block.

The plurality of cooling water channels may include at least a first cooling water channel pertaining to a specific first group, and at least a second cooling water channel pertaining to a specific second group distinguished from the first group, and the first group and the second group may be configured such that amounts of the cooling water flowing per specific unit time with reference to a specific unit area of the battery module are different from each other.

The first group may include a plurality of the plurality of cooling water channels spaced apart from each other by a first spacing distance in the second direction, and the second group may include a plurality of the plurality of cooling water channels spaced apart from each other by a second spacing distance being different from the first spacing distance in the second direction.

The plurality of cooling water channels may include a first cooling water channel group including a cooling water channel for guiding the cooling water in the first direction and a cooling water channel communicated therewith, and for guiding the cooling water in the opposite direction to the first direction, a second cooling water channel group not in communication with the first cooling water channel group on the fixing plate and including a cooling water channel for guiding the cooling water in the first direction and a cooling water channel communicated therewith, and for guiding the cooling water in the third direction.

The distribution manifold may include a front distribution manifold disposed on a front side of the fixing plate in the third direction and configured to distribute the cooling water introduced from a specific introduction pipeline to the first cooling water channel group and the second cooling water channel group, a second front distribution manifold disposed on the front side of the fixing plate, and configured to collect the cooling water discharged from the first cooling water channel group and the second cooling water channel group, and discharge the cooling water to a specific discharge pipeline, and a rear distribution manifold positioned on a rear side of the fixing plate in the third direction, and configured to communicate the cooling water channels pertaining to the first cooling water channel group to return the cooling water flowing in the first direction, in the third direction to the first direction, and configured to communicate the cooling water channels pertaining to the second cooling water channel group to distinguish the cooling water channels in the first cooling water channel group from the cooling water channels in the second cooling water channel group.

The fixing plate may be integrally formed with the plurality of cooling water channels to define the cooling water channels by an inner peripheral surface thereof.

The fixing plate may be manufactured through extrusion.

According to another aspect of the present disclosure, a battery pack system may include a battery tray positioned on a lower side of a battery module, and including a base plate and a vertical wall vertically coupled to the base plate, and a cooling module including a fixing plate disposed between the battery module and the base plate, and including a plurality of cooling water channels extending in a first direction, and spaced apart from each other in a second direction, which is perpendicular to the first direction, and a distribution manifold disposed on an outer side of the fixing plate, and communicating with the plurality of cooling water channels such that the plurality of cooling water channels form flow of cooling water along the first direction and flow of the cooling water along a third direction opposite to the first direction.

The vertical wall may include a rear vertical wall positioned on a rear side of the fixing plate in the third direction, and the distribution manifold may include a rear distribution manifold positioned in the rear vertical wall to communicate with at least a first of the plurality of cooling water channels and at least a second of the plurality of cooling water channels, such that the cooling water flowing in the first direction along the at least any one first cooling water channel circulates in the third direction along the second cooling water channel.

The rear distribution manifold may include a return pipeline positioned in the rear vertical wall, and a rear connection pipeline connecting the return pipeline and the plurality of cooling water channels.

The vertical wall may include a front vertical wall positioned on a front side of the fixing plate in the third direction, and the distribution manifold may include a front distribution manifold positioned in the front vertical wall, and configured to distribute the cooling water introduced from a specific introduction pipeline to a first number of the plurality of cooling water channels, and to collect the cooling water discharged from a second number of the plurality of cooling water channels, and to discharge the cooling water to a specific discharge pipeline.

The front distribution manifold may include a distribution manifold block positioned in the front vertical wall, and a front connection pipeline connecting the distribution manifold block and the plurality of cooling water channels.

The battery module may include a plurality of battery cells extending in the second direction to intersect the plurality of cooling water channels, and spaced apart from each other in the first direction.

### BRIEF DESCRIPTION OF THE FIGURES

The above and other objects, features and advantages of the present disclosure will be more apparent from the following detailed description taken in conjunction with the accompanying drawings:

FIG. 1 is a perspective view of a battery pack system according to an embodiment of the present disclosure;

FIG. 2 is an exploded perspective view of a vertical wall, a cooling module, and a base plate according to an embodiment of the present disclosure;

FIG. 3 is a bottom exploded perspective view of FIG. 2, viewed from a bottom;

FIG. 4 is a plan view illustrating battery cells of a battery module according to an embodiment of the present disclosure;

FIG. 5 is a perspective view of the cooling module according to an embodiment of the present disclosure;

FIG. 6 is a side view of a cooling module according to an embodiment of the present disclosure;

FIG. 7 is a cross-sectional view, taken along line I-I′ illustrated in FIG. 5;

FIG. 8 is a cross-sectional view illustrating a cooling water channel of a cooling module according to an embodiment of the present disclosure;

FIG. 9 is a schematic view illustrating flow of cooling water along a cooling water channel according to an embodiment of the present disclosure;

FIG. 10 is a side view of a battery tray and a cooling module of a battery pack system according to an embodiment of the present disclosure;

FIG. 11 is an enlarged view of portion “A” illustrated in FIG. 10;

FIG. 12 is an enlarged view of portion “B” illustrated in FIG. 10;

FIG. 13 is a schematic view of a battery pack system installed in a vehicle according to an embodiment of the present disclosure; and

FIG. 14 is a flowchart illustrating a method for manufacturing a cooling module according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

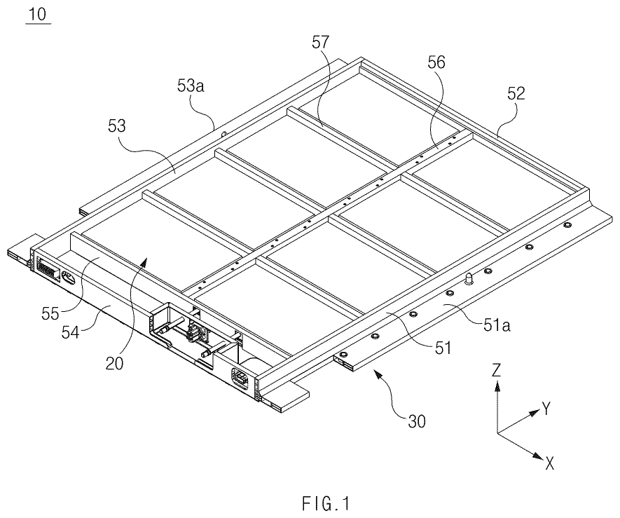

Hereinafter, embodiments of the present disclosure will be described in detail with reference to FIGS. 1 to 14.

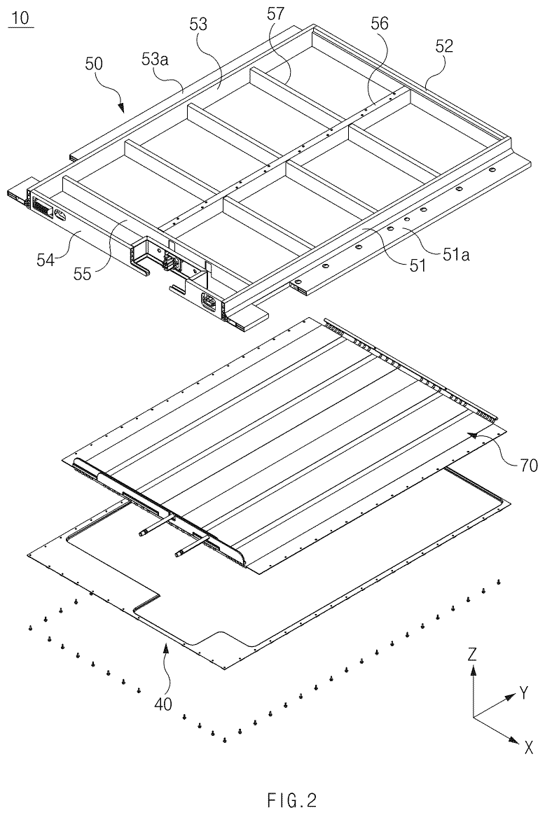

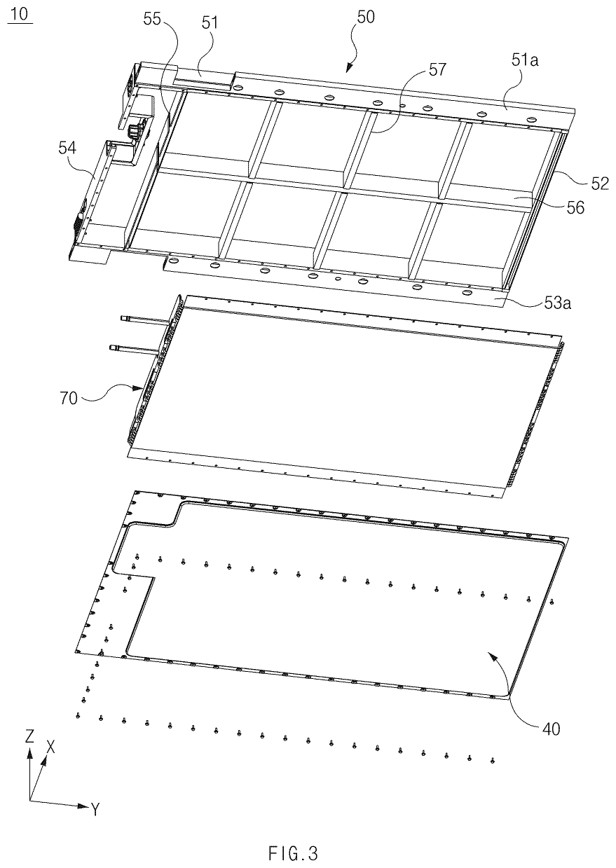

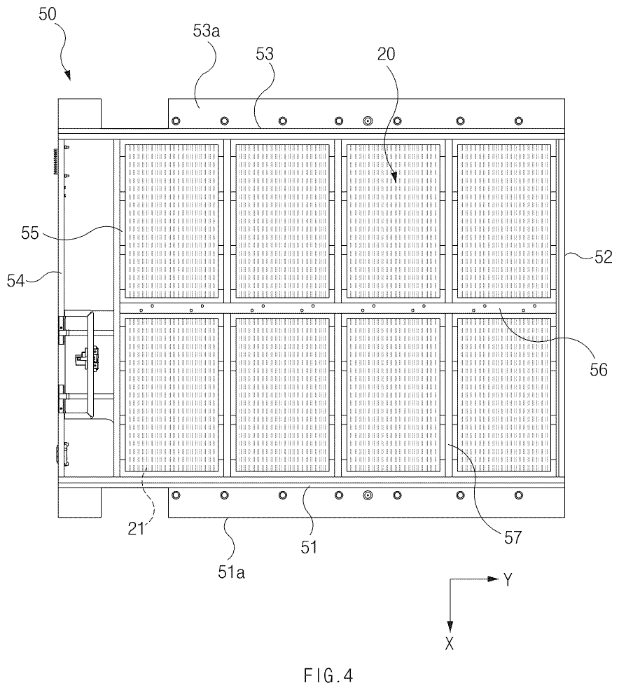

FIG. 1 is a perspective view of a battery pack system according to an embodiment of the present disclosure. FIG. 2 is an exploded perspective view of a vertical wall, a cooling module, and a base plate according to an embodiment of the present disclosure. FIG. 3 is a bottom exploded perspective view of FIG. 2, viewed from a bottom. FIG. 4 is a plan view illustrating battery cells of the battery module according to an embodiment of the present disclosure.

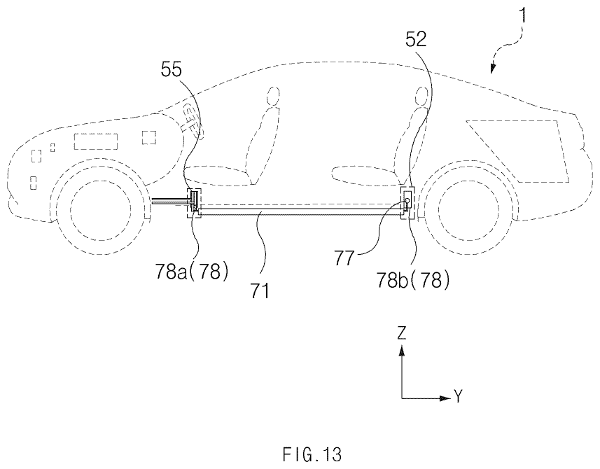

Referring to FIGS. 1 to 4, a battery pack system 10 may be provided in an interior of a vehicle 1 (see FIG. 13) to operate a motor of the vehicle 1. The battery pack system 10 may include a battery module 20 that may be used while charging or discharging electrical energy, a battery tray 30 that may support the battery module 20 while accommodating it, and a cooling module 70 for cooling the battery module 20.

The battery module 20, as illustrated in FIG. 4, may include a plurality of battery cells 21. The battery cells 21 may be lithium-ion batteries.

The plurality of battery cells 21 may be arranged to extend in the leftward/rightward direction (the “X” direction) and be spaced apart from each other in the forward/rearward direction (the “Y” direction). As an example, one battery module 20 may include twenty battery cells 21.

The plurality of battery cells may be used in the form of the battery module 20 to protect the plurality of battery cells from an external shock, heat, vibration, and the like.

The battery tray 30 may be configured to accommodate the battery module 20. The battery tray 30 may include a base plate 40 that is disposed on a lower side of the battery module 20 (the-Z direction) and a vertical wall 50 that is installed vertically on the base plate 40.

The vertical wall 50 may be provided in the form of a frame that extends along a periphery of the battery module 20. The vertical wall 50 may include a first side wall 51, a second side wall 52, a third side wall 53, and a fourth side wall 54 that extend to surround the plurality of battery modules 20.

The first side wall 51 and the third side wall 53 may extend in the forward/rearward direction (the “Y” direction), which is a lengthwise direction of the vertical wall 50. The second side wall 52 and the fourth side wall 54 may extend in the leftward/rightward direction (the “X” direction) that is horizontally perpendicular to the forward/rearward direction.

Here, the second side wall 52 may be referred to as the rear vertical wall 52 that is disposed on a rear side of the battery module 20. Furthermore, the vertical wall 50 may include a front vertical wall 55 that is disposed on a front side of the battery module 20. The front vertical wall 55 may be disposed between the fourth side wall 54 and the rear vertical wall 52.

The vertical wall 50 includes a first mount 51a that is disposed on an outside of the vertical wall 50 from the first side wall 51 and a second mount 53a that is disposed on an outside of the vertical wall 50 from the third side wall 53. The vertical wall 50 may be coupled to the base plate 40 through the first mount 51a and the second mount 53a.

The vertical wall 50 may include a first partition wall 56 and a second partition wall 57 for separating the plurality of battery modules 20 from each other. The first partition wall 56 may extend in the forward/rearward direction from the front vertical wall 55 to the rear vertical wall 52. The second partition wall 57 may connect the first side wall 51 and the first partition wall 56 or the first partition wall 56 and the third side wall 53. In more detail, although eight battery modules 20 are illustrated in FIG. 1, the present disclosure is not limited thereto, and a smaller number of second partition wall 57 than the number of the battery modules may be provided.

The battery module 20 may be mounted in the vehicle 1 in the form of the battery pack system 10. Meanwhile, it is necessary to maintain the battery cell 21 at a constant temperature. When a temperature of the battery cells 21 falls a certain temperature or less, an internal resistance of the battery cells 21 increases, and a driving distance of the vehicle 1 may decrease due to an amount of generated heat, and when the temperature of the battery cells 21 may increase to more than a certain temperature, the battery cells 21 may not be charged to 100%, and thus, the driving distance of the vehicle 1 may also decrease.

As described above, it is necessary to maintain the temperature of the battery cells at the constant temperature. To this end, the vehicle 1 may include a system for cooling or heating the battery module 20.

As a scheme for cooling or heating the battery module 20, a water cooling method of cooling the battery module 20 by using cooling water may be used.

According to an embodiment of the present disclosure, the cooling module 70 may be disposed on a lower side of the battery module 20 to adjust a temperature of the battery module 20. The cooling module 70 may be disposed between the battery module 20 and the base plate 40. However, unlike the illustration of the drawing, the cooling module 70 may be disposed on an upper side (the “Z” direction) of the battery module 20.

The vertical wall 50, the cooling module 70, and the base plate 40 may be coupled to each other by a fastening member that is inserted into a peripheral portion thereof.

Hereinafter, a detailed structure of the cooling module 70 will be described.

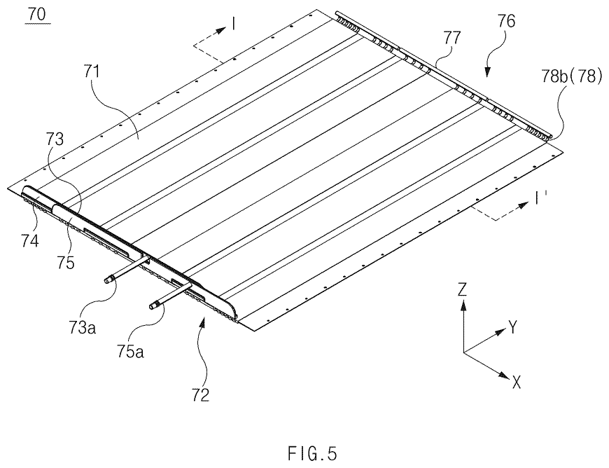

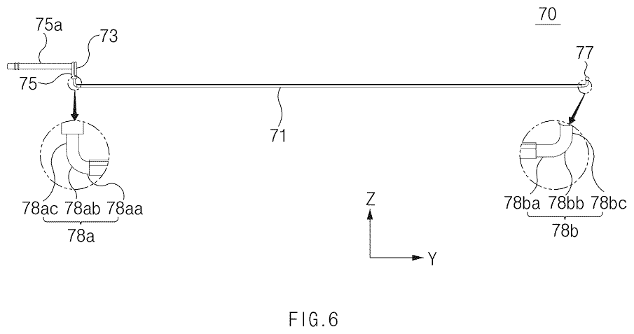

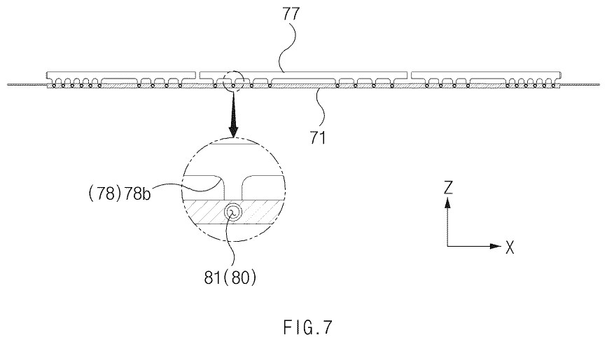

FIG. 5 is a perspective view of the cooling module according to an embodiment of the present disclosure. FIG. 6 is a side view of the cooling module according to an embodiment of the present disclosure. FIG. 7 is a cross-sectional view, taken along line I-I′ illustrated in FIG. 5.

Referring to FIGS. 5 to 7, the cooling module 70 may include a fixing plate 71 including a plurality of cooling water channels 81, and distribution manifolds 72 and 76 that are disposed on an outside off the fixing plate 71 in the forward/rearward direction and are connected to the plurality of cooling water channels 81.

The fixing plate 71 may include the plurality of cooling water channels 81, in which the cooling water for cooling the temperature of the battery module 20, and a manufacturing method of forming the plurality of cooling water channels 81 include a method of forming the cooling water channels in a plate shape through press forming and brazing separate plates.

According to the cooling module 70 according to the present disclosure, the fixing plate 71 may define the plurality of cooling water channels 81 that extend in the forward/rearward direction through extrusion, differently from the method of forming the cooling water channel through press forming.

That is, the fixing plate 71 may be extruded to a rear side (in the Y direction) by an extrusion mold to be formed. The plurality of cooling water channels 81 may be provided and may be formed to be spaced apart from each other in a second direction on a horizontal direction (the “X” direction), which is perpendicular to the first direction while extending in parallel to the first direction that is a rearward direction (the “Y” direction) on the horizontal direction of the fixing plate 71.

Because the fixing plate 71 is manufactured though extrusion, flatness thereof may be further improved compared to a manufacturing method of brazing. Furthermore, the fixing plate 71 does not require a fusion process that may occur when the fixing plate 71 is manufactured by using a manufacturing method, such as brazing, and thus, the process may be simplified. Furthermore, because the fixing plate 71 defines the plurality of cooling water channels 81 by the inner peripheral surfaces thereof as one component, a strength of the plurality of cooling water channels 81 may be further improved.

The cooling module 70 may include an introduction pipeline 73a, through which external cooling water is introduced into the cooling module 70, and a discharge pipeline 75a, through which the cooling water that circulates through the cooling water channels 81 is discharged to an outside.

Meanwhile, because the cooling module 70 is manufactured by an extrusion mold, the plurality of cooling water channels 81 may be provided to extend rearward.

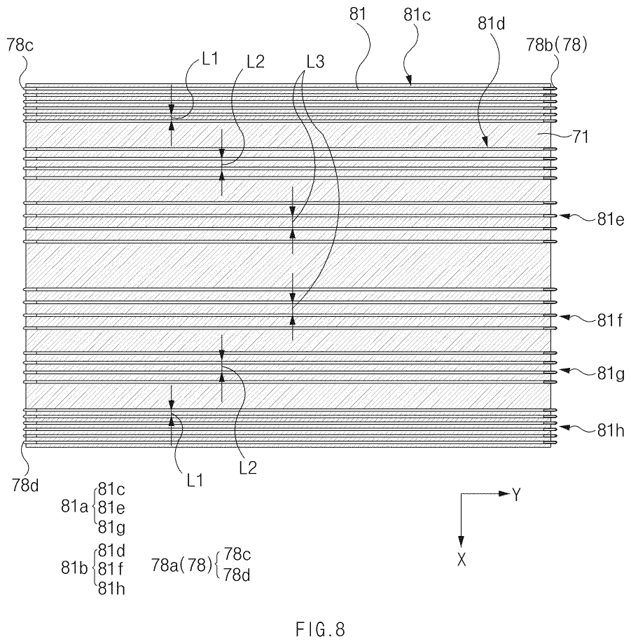

The plurality of cooling water channels 81 may include a plurality of first cooling water channels 81a (see FIG. 8) that are branched from the introduction pipeline 73a and through which the cooling water flows toward a rear side (the “Y” direction) in the opposite direction to the first direction, and a plurality of second cooling water channels 81b, through which the cooling water flows toward a front side (the-Y direction) that is an opposite direction to the plurality of first cooling water channels 81a.

Due to this structure, the cooling module 70 may require a separate configuration for communicate a part, through which the external cooling water is introduced, and a part, through which the circulating cooling water is discharged to the outside.

Accordingly, the cooling module 70 may include the distribution manifolds 72 and 76 that connects the cooling water channels 81 such that form flow of the cooling water along the rear side and flow of the cooling water along the front side.

The distribution manifolds 72 and 76 may include the front distribution manifold 72 that is disposed on a front side of the fixing plate 71 and the rear distribution manifold 76 that is disposed on a rear side of the fixing plate 71.

In more detail, the rear distribution manifold 76 may be disposed on the rear side of the fixing plate 71 to communicate the plurality of first cooling water channels 81a and the second cooling water channels 81b such that the cooling water flowing rearward along at least any one of the plurality of first cooling water channels 81a circulates forward along at least any one of the plurality of second cooling water channels 81b on the front side of the fixing plate 71.

The rear distribution manifold 76 may include a return pipeline 77 that is disposed on an upper side of the fixing plate 71, and a rear connection pipeline 78b that connects the return pipeline 77 and the cooling water channels 81. The return pipeline 77 may extend in the leftward/rightward direction (the “X” direction). The return pipeline 77 may include a first return pipeline 77a, a second return pipeline 77b, and a third return pipeline 77c that are spaced apart from each other in the leftward/rightward direction.

The rear connection pipeline 78b may communicate the plurality of first cooling water channels 81a and the plurality of second cooling water channels 81b with the return pipeline 77. Because the return pipeline 77 is located on an upper side of the fixing plate 71, the rear connection pipeline 78b may be bent upward from rear ends of the plurality of cooling water channels 81 toward the return pipeline 77.

Meanwhile, the plurality of first cooling water channels 81a and the plurality of second cooling water channels 81b also may be provided. Due to the structure, the distribution manifolds 72 and 76 may include the front distribution manifold 72 that is configured to distribute the cooling water from the introduction pipeline 73a, into which cooling water is introduced into the plurality of first cooling water channels 81a, and collect the cooling water discharged from the second cooling water channels 81b, and discharge the cooling water to the discharge pipeline 75a, from which the cooling water is discharged. The front distribution manifold 72 may be disposed on a front side of the fixing plate 71 in an opposite direction to the first direction (the “Y” direction).

The front distribution manifold 72 may include first front distribution manifolds 73 and 78c that are configured to be branched from the introduction pipeline 73a to the plurality of first cooling water channels 81a, and second front distribution manifolds 75 and 78d that are configured to be branched from the discharge pipeline 75a to the plurality of second cooling water channels 81b.

The first front distribution manifolds 73 and 78c may include a first distribution manifold block 73 that is disposed on an upper side of the fixing plate 71 and extends in the second direction (the “X” direction) that is a leftward/rightward direction, and a first front connection pipeline 78c (see FIG. 8) that connects the first distribution manifold block 73 and the plurality of first cooling water channels 81a.

The second front distribution manifolds 75 and 78d may include a second distribution manifold block 75 that is disposed on an upper side of the fixing plate 71 and extends in the second direction (the “X” direction) that is a leftward/rightward direction, and a second front connection pipeline 78d that connects the second distribution manifold block 75 and the plurality of second cooling water channels 81b.

The first distribution manifold block 73 and the second distribution manifold block 75 may be disposed on an upper side of the fixing plate 71 and extend in parallel to each other, and a distribution manifold block support portion 74 may be provided therebetween.

Meanwhile, the connection pipeline 78 includes a front connection pipeline 78a that connects the plurality of cooling water channels 81 and the distribution manifold blocks 73 and 75, and a rear connection pipeline 78b that connects the plurality of cooling water channels 81 and the return pipeline 77. Because all of the distribution manifold blocks 73 and 75 and the return pipeline 77 are located on an upper side of the fixing plate 71, the front connection pipeline 78a and the rear connection pipeline 78b may be bent upward from the cooling water channels 81.

In more detail, the front connection pipeline 78a may include a horizontal part 78aa that is coupled to the fixing plate 71 to be adjacent to front ends of the plurality of cooling water channels 81, a vertical part 78ac that is connected to the distribution manifold blocks 73 and 75, and a bending part 78ab that is disposed between the horizontal part 78aa and the vertical part 78ac to be bent. The vertical part 78ac may extend upward from the horizontal part 78aa. The bending part 78ab may be formed in a shape of ‘L’.

The front connection pipeline 78a may include the first front connection pipeline 78c that is connected to the first front distribution manifold block 73 and the second front connection pipeline 78d that is connected to the second front distribution manifold block 75, and the first front connection pipeline 78c and the second front connection pipeline 78d may differ only in the objects to be connected, and the structures thereof may correspond to each other.

The rear connection pipeline 78b may include a horizontal part 78ba that is coupled to the fixing plate 71 to be adjacent to the rear ends of the cooling water channels 81, a vertical part 78bc that is connected to the return pipeline 77, and a bending part 78bb that is disposed between the horizontal part 78ba and the vertical part 78bc to be bent. The vertical part 78bc may extend upward from the horizontal part 78ba. The bending part 78bb may be formed in a shape of ‘L’.

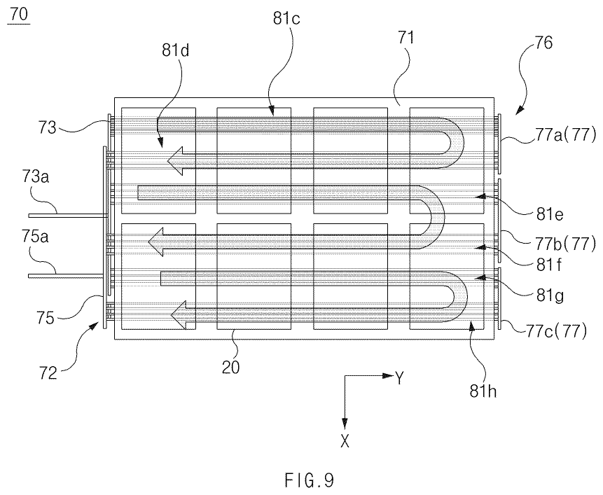

FIG. 8 is a cross-sectional view illustrating the cooling water channel of the cooling module according to an embodiment of the present disclosure. FIG. 9 is a schematic view illustrating the flow of cooling water along the cooling water channel according to an embodiment of the present disclosure.

Referring to FIGS. 8 and 9, the plurality of cooling water channels 81 may intersect the plurality of battery cells 21 (see FIG. 4). In other words, the plurality of cooling water channels 81 may extend in a direction that is perpendicular to the direction, in which the plurality of battery cells 21 extend. That is, the plurality of cooling water channels 81 may extend in a direction corresponding to the direction, in which the plurality of battery cells 21 are stacked.

Here, the plurality of battery cells 21 may be stacked to be spaced apart from each other in the forward/rearward direction (the “Y” direction), and the plurality of cooling water channels 81 may extend in the forward/rearward direction (the “Y” direction) and may be spaced apart from each other in the leftward/rightward direction (the “X” direction) that is perpendicular to the forward/rearward direction.

The reason why the plurality of cooling water channels 81 extend perpendicularly to the direction, in which the plurality of battery cells 21 extend, is that one cooling water channel 81 may be disposed to pass under the plurality of battery cells 21 whereby the performance of each battery cell 21 may be uniformly maintained by reducing a deviation of the cooling effects of the adjacent battery cells 21.

When the plurality of cooling water channels 81 extend in parallel to the direction, in which the plurality of battery cells 21 extend, one cooling water channel 81 may pass only under one battery cell 21 whereby a deviation of the cooling effects of the adjacent battery cells 21 may occur.

Meanwhile, the plurality of cooling water channels 81 may be classified into the plurality of cooling water channels 81 pertaining to the first group and the plurality of cooling water channels 81 pertaining to the second group distinct from the first group.

A larger amount of the cooling water may be configured to flow per specific unit time with reference to a specific unit area of the battery module in the cooling water channels 81 located at peripheries of the fixing plate 71 in the leftward/rightward direction than in the cooling water channels 81 located in an inner part of the fixing plate 71 in the leftward/rightward direction.

Here, the cooling water channels 81 that are located adjacent to the peripheries of the fixing plate 71 in the leftward/rightward direction may be the cooling water channels pertaining to the first group, and the cooling water channels 81 located in the inner part of the fixing plate 71 in the leftward/rightward direction than the cooling water channels belonging to the first group may be the cooling water channels pertaining to the second group that is distinguished from the first group.

Among the plurality of cooling water channels 81, the cooling water channels 81 that are closer to the periphery of the fixing plate 71 may be influenced more by an ambient temperature than the cooling water channels 81 located inside the fixing plate 71 whereby the cooling effect of the battery module 20 may be relatively low. Accordingly, a larger amount of the cooling water flows for a specific unit time period with reference to a specific unit area of the battery module in the cooling water channels 81 located adjacent to the peripheries of the fixing plate 71 in the leftward/rightward direction than in the cooling water channels 81 located in the inner part of the fixing plate 71 in the leftward/rightward direction to reduce a deviation of the cooling effect of the battery module 20.

As an example, a smaller spacing distance may be provided in the cooling water channels 81 located adjacent to the peripheries of the fixing plate 71 in the leftward/rightward direction than in the cooling water channels 81 located in the inner part of the fixing plate 71 in the leftward/rightward direction to reduce a deviation of the cooling effects of the battery module 20.

In other words, the spacing distance between the plurality of cooling water channels 81 may not be the same. That is, the spacing distance between the plurality of cooling water channels 81 are located on the outside in the leftward/rightward direction may be provided to be smaller than the spacing distance between the plurality of cooling water channels 81 located on the inner part of the fixing plate 71 in the leftward/rightward direction.

In more detail, referring to FIGS. 8 and 9, the plurality of first cooling water channels 81a may include a plurality of third cooling water channels 81c that are provided at a peripheral portion of one side of the fixing plate 71 in the leftward/rightward direction, are spaced apart from each other by a first spacing distance L1, and connect the first distribution manifold block 73 and the first return pipeline 77a.

The plurality of second cooling water channels 81b may include a plurality of fourth cooling water channels 81d that are disposed on an inside of the fixing plate 71 than the plurality of third cooling water channels 81c, are spaced part from each other by a second spacing distance L2 that is larger than the first spacing distance L1, and connect the second distribution manifold block 75 and the first return pipeline 77a. The plurality of fourth cooling water channels 81d may be configured such that cooling water that flows through the plurality of third cooling water channels 81c circulates through the first return pipeline 77a.

The plurality of first cooling water channels 81a may include a plurality of fifth cooling water channels 81e that are disposed on an inside of the plurality of fourth cooling water channels 81d, are spaced apart from each other by a third spacing distance L3 that is larger than the second spacing distance L2, and connect the first distribution manifold block 73 and the second return pipeline 77b.

The plurality of second cooling water channels 81b may include a plurality of sixth cooling water channels 81f that are configured such that the cooling water that flows through the plurality of fifth cooling water channels 81e circulates through the second return pipeline 77b and are spaced apart from each other by the third spacing distance L3. The plurality of sixth cooling water channels 81f may connect the second distribution manifold block 75 and the second return pipeline 77b. The plurality of fifth cooling water channels 81e and the plurality of sixth cooling water channels 81f may be arranged in symmetrical positions of the fixing plate 71 in the leftward/rightward direction.

The plurality of first cooling water channels 81a may include a plurality of seventh cooling water channels 81g that are disposed on an outside of the plurality of sixth cooling water channels 81e, are spaced apart from each other by the second spacing distance L2 that is smaller than the third spacing distance L3, and connect the first distribution manifold block 73 and the third return pipeline 77c. The plurality of seventh cooling water channels 81g may be arranged in symmetrical positions of the fixing plate 71 in the leftward/rightward direction with the plurality of fourth cooling water channels 81d.

The plurality of second cooling water channels 81b may include a plurality of eighth cooling water channels 81h that are disposed on an outside of the plurality of seventh cooling water channels 81g and are disposed at peripheries of an opposite side of the fixing plate 71 in the leftward/rightward direction. The plurality of eighth cooling water channels 81h may be arranged at symmetrical positions of the fixing plate 71 in the leftward/rightward direction with the plurality of third cooling water channels 81c. The plurality of eighth cooling water channels 81h may be channels that connect the second distribution manifold block 75 and the third return pipeline 77c, and through which the cooling water that flows through the plurality of seventh cooling water channels 81g and circulates through the third return pipeline 77c is discharged.

According to the structure, as described above, the cooling effects may be different depending on a location of the battery module 20 in the leftward/rightward direction, and a deviation of the performance of the plurality of battery cells 21 may be reduced by relatively reducing the deviation of the cooling effects or the plurality of battery cells 21.

The plurality of third to eighth cooling water channels 81c to 81h described above may be cooling water groups that are distinguished from each other.

However, the present disclosure is not limited thereto, and the spacing distance of the plurality of cooling water channels 81 located at peripheral portions of the fixing plate 71 in the leftward/rightward direction may be larger than that of the plurality of cooling water channels 81 located in the inner part of the fixing plate 71 in the leftward/rightward direction.

However, the spacing distance between the plurality of cooling water channels 81 that are adjacent to each other is not adjusted depending on the arrangement of the fixing plate 71 in the leftward/rightward direction, but the spacing distance between the plurality of third cooling water channels 81c may correspond to the spacing distance between the plurality of fourth cooling water channels 81d and the number of the plurality of third cooling water channels 81c may be larger than the number of the plurality of fourth cooling water channels 81d.

Furthermore, the plurality of first cooling water channels 81a and the plurality of second cooling water channels 81b may be alternately arranged. In more detail, the plurality of fourth cooling water channels 81d may be provided between the plurality of third cooling water channels 81c and the plurality of fifth cooling water channels 81e, and the plurality of fifth cooling water channels 81e may be provided between the plurality of fourth cooling water channels 81d and the plurality of sixth cooling water channels 81f.

Similarly, the plurality of sixth cooling water channels 81f may be provided between the plurality of fifth cooling water channels 81e and the plurality of seventh cooling water channels 81g, and the plurality of seventh cooling water channels 81g may be provided between the plurality of sixth cooling water channels 81f and the plurality of eighth cooling water channels 81h.

The reason why some of the plurality of first cooling water channels 81a and some of the plurality of second cooling water channels 81b are alternately arranged is that the cooling effect of the battery module 20 in an area that is adjacent to a part, in which the cooling water is introduced through the introduction pipeline 73a, is higher than the cooling effect of the battery module 20 in an area that is adjacent to a part, in which the cooling water is discharged through the discharge pipeline 75a.

In other words, in a structure, in which the plurality of first cooling water channels 81a are all disposed on one side of the fixing plate 71 in the leftward/rightward direction and the plurality of second cooling water channels 81b are all disposed on an opposite side of the fixing plate 71 in the leftward/rightward direction, a deviation of the performances of the battery module 20 disposed on the one side and the battery module 20 disposed on the opposite side becomes greater whereby the entire efficiency of the vehicle may deteriorate.

In contrast, because the deviation of the performance of the battery module 20 depending on the location thereof may be reduced in the arrangement of the plurality of first cooling water channels 81a and the plurality of second cooling water channels 81b of the present disclosure, the entire efficiency of the vehicle may be improved.

In other words, the plurality of cooling water channels 81 of the present disclosure may be classified into a first cooling water channel group including the plurality of third cooling water channels 81c and the plurality of fourth cooling water channels 81d, a second cooling water channel group including the plurality of fifth cooling water channels 81e and the plurality of sixth cooling water channels 81f, and a third cooling water channel group including the plurality of seventh cooling water channels 81g and the plurality of eighth cooling water channels 81h. The first cooling water channel group 81c and 81d, the second cooling water channel group 81e and 81f, and the third cooling water channel group 81g and 81h may not be communicated with each other on the fixing plate 71.

Furthermore, for the structure, the first front distribution manifolds 73 and 78c may distribute the cooling water introduced from the introduction pipeline 73a to the first cooling water channel group 81c and 81d, the second cooling water channel group 81e and 81f, and the third cooling water channel group 81g and 81h. Similarly, the second front distribution manifolds 75 and 78d may collect the cooling water discharged from the first cooling water channel group 81c and 81d, the second cooling water channel group 81e and 81f, and the third cooling water channel group 81g and 81h, and may discharge the cooling water to the discharge pipeline 75a. Correspondingly, the rear distribution manifold 76 may communicate the cooling water channels 81c and 81d pertaining to the first cooling water channel group 81c and 81d to return the cooling water that flows in the first direction (the “X” direction), may communicate the cooling water channels 81e and 81f pertaining to the second cooling water channel group 81e and 81f such that they are distinguished, and may communicate the cooling water channels 81g and 81h pertaining to the third cooling water channel group 81g and 81h such that they are distinguished.

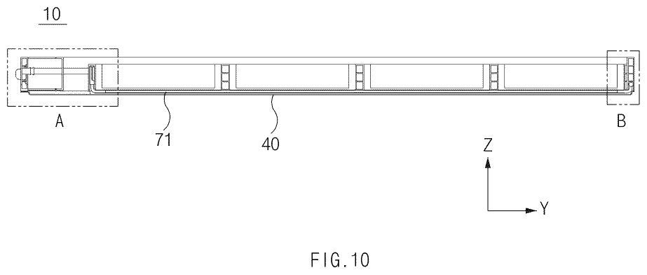

Hereinafter, a structure, in which the cooling module 70 is supported by the battery tray 30 more stably, will be described with reference to FIGS. 10 to 13.

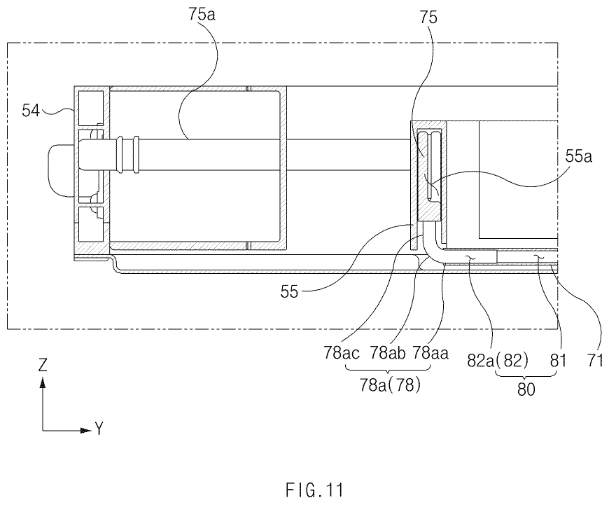

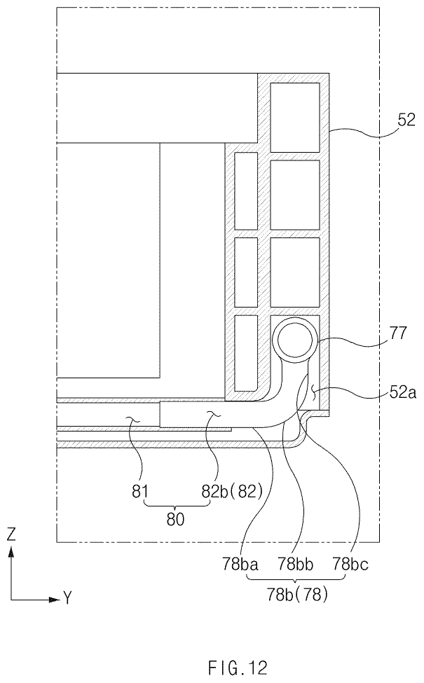

FIG. 10 is a side view of the battery tray and the cooling module of the battery pack system according to an embodiment of the present disclosure. FIG. 11 is an enlarged view of portion “A” illustrated in FIG. 10. FIG. 12 is an enlarged view of portion “B” illustrated in FIG. 11. FIG. 13 is a schematic view of the battery system installed in the vehicle according to an embodiment of the present disclosure.

Referring to FIGS. 2, 5, 10, and 13, the cooling module 70 of the battery pack system 10 may be disposed on a lower side of the vertical wall 50 to be located on a lower side of the battery module 20 and may be disposed on an upper surface of the base plate 40.

The front distribution manifold 72 of the cooling module 70 may be inserted into the front vertical wall 55, and the rear distribution manifold 76 may be inserted into the rear vertical wall 52.

The front vertical wall 55 may define a front accommodation groove 55a that is opened downward such that the first distribution manifold block 73 and the second distribution manifold block 75 are accommodated therein, and the distribution manifold blocks 73 and 75 and a distribution manifold block support part 74 may be accommodated in the front accommodation groove 55a.

The front connection pipeline 78a may include the vertical part 78ac that extends upward from the horizontal part 78aa coupled to the fixing plate 71 toward the front vertical wall 55. The vertical part 78ac of the front connection pipeline 78a may be inserted into the front accommodation groove 55a and may be connected to the distribution manifold block 73 and 75.

The front connection pipeline 78a may communicate the cooling water channel 81 with the distribution manifold blocks 73 and 75 through a header guide channel 82a of a guide channel 82, which is provided in an interior thereof, and through this, the flow of the cooling water may flow through a cooling water flow part 80 more smoothly.

In addition, the front connection pipeline 78a does not cause the cooling water that flows through the cooling water channel 81 to flow as it is, but guides the cooling water in an opposite direction to the gravitational force whereby a vortex that may be generated due to the flow of the cooling water may be prevented.

In more detail, because a velocity of the cooling water that flows in the forward direction (the-Y direction) through the horizontal part 78aa of the front connection pipeline 78a may become lower due to the bending part 78ab and the vertical part 78ac, a vortex may be prevented from generating when the velocity of the cooling water at an upstream side thereof is slower than the velocity of the cooling water on a downstream side that is a flow direction of the cooling water.

The rear vertical wall 52 may be coupled to the base plate 40. The rear vertical wall 52 may define a rear accommodation groove 52a that is opened downward such that the return pipeline 77 is accommodated therein, and the return pipeline 77 may be accommodated in the rear accommodation groove 52a.

The rear connection pipeline 78b may extend upward to be inserted from the horizontal part 78ba coupled to the fixing plate 71 toward the rear vertical wall 52. That is, the vertical part 78bc of the rear connection pipeline 78b may be bent from the horizontal part 78ba to be inserted into the rear accommodation groove 52a.

The rear connection pipeline 78b may communicate the cooling water channel 81 with the return pipeline 77 through a return guide channel 82b of the guide channel 82, which is provided in an interior thereof, and through this, the cooling water may flow in the cooling water flow part 80 more smoothly.

Furthermore, as in the front connection pipeline 78a, the velocity of the cooling water that flows through the rear connection pipeline 78b in the rearward direction (the “Y” direction) may be adjusted through the bending part 78bb and the vertical part 78bc whereby a vortex may be prevented from being generated due to the flow of the cooling water.

According to the structure, the distribution manifolds 72 and 76 may be accommodated by the vertical wall 50 more stably. Furthermore, due to the characteristics of the fixing plate 71 formed through extrusion, the distribution manifolds 72 and 76 have to be disposed on an outside of the fixing plate 71, and stability may be improved by reducing a danger of damage of the distribution manifolds 72 and 76 even when a collision accident in the forward/rearward direction of the vehicle 1 occurs, and a separate cover does not have to be manufactured as well whereby a weight thereof may be prevented from increasing and manufacturing costs may be relatively reduced.

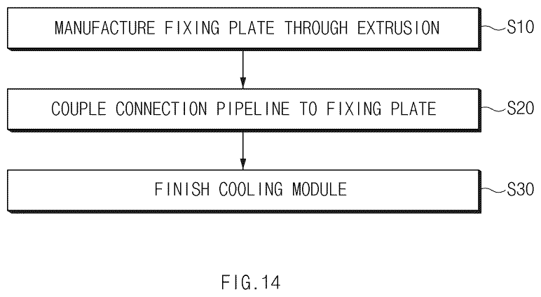

FIG. 14 is a flowchart illustrating a method for manufacturing the cooling module according to an embodiment of the present disclosure.

The method for manufacturing the cooling module 70 will be described with reference to FIGS. 5, 7, and 14. The fixing plate 71 may be extruded in the first direction by an extrusion mold to be manufactured as described above (S10). Then, the fixing plate 71 and the cooling water channel 81 may be integrally extruded as one configuration.

Thereafter, the introduction pipeline 73a, the discharge pipeline 75a, the distribution manifold blocks 73 and 75, and the plurality of first cooling water channels 81a (see FIG. 8) may be communicated with each other by inserting or coupling the front connection pipeline 78a to one side of the fixing plate 71 in the first direction (S20).

Furthermore, the return pipeline 77 and the plurality of second cooling water channels 81b may be communicated with each other by inserting or coupling the rear connection pipeline 78b to an opposite side of the fixing plate 71 in the first direction.

The cooling module 70 according to an embodiment of the present disclosure is finished through the manufacturing sequence (S30).

In the fixing plate 71 through the above-described extrusion, the cooling water channels 81 may be integrally formed whereby a strength thereof may be improved and a size of the mold may be reduced for improvement of productivity.

Because the technology may manufacture the fixing plate of the cooling module though extrusion, productivity may be improved.

Furthermore, the present technology is an integral configuration, and the fixing plate including the cooling water channels may be manufactured, and thus, the strength of the cooling module may be improved.

In addition, according to the present technology, because the distribution manifold may be accommodated in the battery tray, damage to the distribution manifold may be prevented and thus safety may be improved.

In addition, various effects recognized directly or indirectly through the present document may be provided.

The above description is a simple exemplary description of the technical spirits of the present disclosure, and an ordinary person in the art, to which the present disclosure pertains, may make various corrections and modifications without departing from the essential characteristics of the present disclosure.

Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

1. A cooling module comprising:
a fixing plate positioned on a lower side of a battery module, and including a plurality of cooling water channels extending in a first direction, and spaced apart from each other in a second direction which is perpendicular to the first direction; and
a distribution manifold positioned on an outer side of the fixing plate, and communicating with the plurality of cooling water channels such that the plurality of cooling water channels form a flow of cooling water along the first direction and a flow of the cooling water along a third direction which is opposite to the first direction.

2. The cooling module of claim 1, wherein the distribution manifold includes a rear distribution manifold positioned on a rear side of the fixing plate in the third direction and configured to communicate with at least a first of the plurality of cooling water channels and at least a second of the plurality of cooling water channels such that the cooling water flowing in the first direction along the first cooling water channel circulates in the third direction along the second cooling water channel.

3. The cooling module of claim 2, wherein the rear distribution manifold includes:
a return pipeline positioned on an upper side of the fixing plate and extending in the second direction; and
a rear connection pipeline connecting the return pipeline and the plurality of cooling water channels.

4. The cooling module of claim 3, wherein the rear connection pipeline includes:
a horizontal part coupled to the fixing plate; and
a vertical part extending from the horizontal part and connected to the return pipeline.

5. The cooling module of claim 1, wherein the distribution manifold includes a front distribution manifold positioned on a front side of the fixing plate in the third direction,
wherein the front distribution manifold is configured to distribute the cooling water introduced from a specific introduction pipeline to a first number of the plurality of cooling water channels, and to collect the cooling water discharged from a second number of the plurality of cooling water channels, and to discharge the cooling water to a specific discharge pipeline.

6. The cooling module of claim 5, wherein the front distribution manifold includes:
a first front distribution manifold configured to be branched from the introduction pipeline to a first number of the plurality of cooling water channels; and
a second front distribution manifold configured to be branched from the discharge pipeline to a second number of the plurality of cooling water channels.

7. The cooling module of claim 6, wherein the first front distribution manifold includes:
a first distribution manifold block connected to the introduction pipeline, extending in the second direction, and positioned on an upper side of the fixing plate; and
a first front connection pipeline connecting the first distribution manifold block and a third number of the plurality of cooling water channels, and
wherein the second front distribution manifold includes:
a second distribution manifold block connected to the discharge pipeline, extending in the second direction, and positioned on the upper side of the fixing plate; and
a second front connection pipeline connecting the second distribution manifold block and a fourth number of the plurality of cooling water channels.

8. The cooling module of claim 7, wherein the first front connection pipeline includes:
a horizontal part coupled to the fixing plate; and
a vertical part extending from the horizontal part and connected to the first distribution manifold block, and
wherein the second front connection pipeline includes:
a horizontal part coupled to the fixing plate; and
a vertical part extending from the horizontal part and connected to the second distribution manifold block.

9. The cooling module of claim 1, wherein the plurality of cooling water channels include at least a first cooling water channel pertaining to a specific first group, and at least a second cooling water channel pertaining to a specific second group distinguished from the first group, and
wherein the first group and the second group are configured such that amounts of the cooling water flowing per specific unit time with reference to a specific unit area of the battery module are different from each other.

10. The cooling module of claim 9, wherein the first group includes a plurality of the plurality of cooling water channels spaced apart from each other by a first spacing distance in the second direction, and
wherein the second group includes a plurality of the plurality of cooling water channels spaced apart from each other by a second spacing distance being different from the first spacing distance in the second direction.

11. The cooling module of claim 1, wherein the plurality of cooling water channels include:
a first cooling water channel group including a cooling water channel for guiding the cooling water in the first direction and a cooling water channel communicated therewith, and for guiding the cooling water in the opposite direction to the first direction; and
a second cooling water channel group not in communication with the first cooling water channel group on the fixing plate and including a cooling water channel for guiding the cooling water in the first direction and a cooling water channel communicated therewith, and for guiding the cooling water in the third direction.

12. The cooling module of claim 11, wherein the distribution manifold includes:
a front distribution manifold disposed on a front side of the fixing plate in the third direction and configured to distribute the cooling water introduced from a specific introduction pipeline to the first cooling water channel group and the second cooling water channel group;
a second front distribution manifold disposed on the front side of the fixing plate, and configured to collect the cooling water discharged from the first cooling water channel group and the second cooling water channel group, and discharge the cooling water to a specific discharge pipeline; and
a rear distribution manifold positioned on a rear side of the fixing plate in the third direction, and configured to communicate the cooling water channels pertaining to the first cooling water channel group to return the cooling water flowing in the first direction, in the third direction, and configured to communicate the cooling water channels pertaining to the second cooling water channel group to distinguish the cooling water channels in the first cooling water channel group from the cooling water channels in the second cooling water channel group.

13. The cooling module of claim 1, wherein the fixing plate is integrally formed with the plurality of cooling water channels to define the cooling water channels by an inner peripheral surface thereof.

14. The cooling module of claim 1, wherein the fixing plate is manufactured through extrusion.

15. A battery pack system comprising:
a battery tray positioned on a lower side of a battery module, and including a base plate and a vertical wall vertically coupled to the base plate; and
a cooling module including a fixing plate positioned between the battery module and the base plate and including a plurality of cooling water channels extending in a first direction, and spaced apart from each other in a second direction, which is perpendicular to the first direction, and a distribution manifold disposed on an outer side of the fixing plate and communicating with the plurality of cooling water channels such that the plurality of cooling water channels form flow of cooling water along the first direction and flow of the cooling water along a third direction opposite to the first direction.

16. The battery pack system of claim 15, wherein the vertical wall includes a rear vertical wall positioned on a rear side of the fixing plate in the third direction, and
wherein the distribution manifold includes a rear distribution manifold positioned in the rear vertical wall to communicate with at least a first of the plurality of cooling water channels and at least a second of the plurality of cooling water channels, such that the cooling water flowing in the first direction along the first cooling water channel circulates in the third direction along the second cooling water channel.

17. The battery pack system of claim 16, wherein the rear distribution manifold includes:
a return pipeline positioned in the rear vertical wall; and
a rear connection pipeline connecting the return pipeline and the plurality of cooling water channels.

18. The battery pack system of claim 15, wherein the vertical wall includes a front vertical wall positioned on a front side of the fixing plate in the third direction, and
wherein the distribution manifold includes a front distribution manifold positioned in the front vertical wall, and configured to distribute the cooling water introduced from a specific introduction pipeline to a first number of the plurality of cooling water channels, and to collect the cooling water discharged from a second number of the plurality of cooling water channels, and to discharge the cooling water to a specific discharge pipeline.

19. The battery pack system of claim 18, wherein the front distribution manifold includes:
a distribution manifold block positioned in the front vertical wall; and
a front connection pipeline connecting the distribution manifold block and the plurality of cooling water channels. 20 The battery pack system of claim 15, wherein the battery module includes a plurality of battery cells extending in the second direction to intersect the plurality of cooling water channels, and spaced apart from each other in the first direction.
